(19) United States
(12) Patent Application Publication
(10) Pub. No.: US 2024/0416361 A1
(43) Pub. Date: Dec. 19, 2024

(54) ELECTROSTATIC DUST COLLECTOR-PURIFIER

(71) Applicant: Kunshan Hunghsing Electric Co., Ltd., Kunshan (CN)

(72) Inventors: Jiazhang LI, Kunshan (CN); Yingbin HUANG, Kunshan (CN); Yanji NIU, Kunshan (CN); Xiangshang LI, Kunshan (CN)

(73) Assignee: Kunshan Hunghsing Electric Co., Ltd., Kunshan (CN)

(21) Appl. No.: 18/603,834

(22) Filed: Mar. 13, 2024

(30) Foreign Application Priority Data
Jun. 15, 2023 (CN) 202310711636.6

(51) Int. Cl. B03C 3/019; B03C 3/08; B03C 3/36; B03C 3/41; B03C 3/47

(52) U.S. Cl. CPC B03C 3/019; B03C 3/08; B03C 3/368; B03C 3/41; B03C 3/47; B03C 2201/04

(57) ABSTRACT

An electrostatic dust collector-purifier is provided, which includes a top cover, a base, two side baffles, a front grille, and a rear grille, characterized by: a power generation mechanism, the power generation mechanism being located inside the base and including a high-voltage generator, a low-voltage terminal fixedly connected to one side of the high-voltage generator, and a ground terminal fixedly connected to one side of the high-voltage generator; a dust collection mechanism, the dust collection mechanism being located between the base and the top cover, the dust collection mechanism including a metal dust collection support and a metal electrode sheet fixedly connected to the interior of the metal dust collection support, the metal dust collection support being washable and reusable; and a filtering mechanism, the filtering mechanism being located between the base and the top cover.

### CROSS-REFERENCE TO RELATED APPLICATIONS

This application claims priority to Chinese Application No. 202310711636.6, having a filing date of Jun. 15, 2023, the entire contents of which are hereby incorporated by reference.

### TECHNICAL FIELD

The present invention relates to the technical field of dust collectors and purifiers, and in particular to an electrostatic dust collector-purifier.

### BACKGROUND OF THE INVENTION

The high-voltage electrostatic precipitator, as a device that uses electrostatic purification to collect dust particles in the air, realizes purification mainly relying on two systems of discharge electrode and dust collecting electrode. When high-voltage direct current is input between the two electrodes, anions and cations will be generated in an electrode space and act on the surface of the exhaust gas particles passing through the electrostatic field, and the exhaust gas particles move to the electrodes with opposite polarity under the action of the electric field force and are deposited on the electrodes to achieve dust collection. In order to achieve better dust collection effect, higher DC voltage and discharge intensity are required. Most electrostatic air purifiers currently available on the market use composite purification, which captures tiny particles in the air while absorbing released ozone. The release of ozone needs to comply with environmental standards, which limits the achievement of a better purification effect. Therefore, we provide an electrostatic dust collector-purifier.

### SUMMARY OF THE INVENTION

The present invention provides an electrostatic dust collector-purifier to solve the above-mentioned shortcomings in the prior art.

In order to achieve the above objective, the present invention adopts the following technical solution:

An electrostatic dust collector-purifier, including a top cover, a base, two side baffles, a front grille, and a rear grille, characterized by
a power generation mechanism, the power generation mechanism being located inside the base and including a high-voltage generator, a low-voltage terminal fixedly connected to one side of the high-voltage generator, and a ground terminal fixedly connected to one side of the high-voltage generator;
a dust collection mechanism, the dust collection mechanism being located between the base and the top cover and including a metal dust collection support and a metal electrode sheet fixedly connected to the interior of the metal dust collection support, the metal dust collection support being washable and reusable, thereby reducing waste and environmental pollution; and
a filtering mechanism, the filtering mechanism being located between the base and the top cover as well as between the front grille and the metal dust collection support and including a filter support and an ozone filter fixedly connected to the interior of the filter support.

Further, the power generation mechanism further includes a power cord fixedly connected to the high-voltage generator, one end of the power cord is connected to an input end of the high-voltage generator, a placement slot is provided inside the base, and the high-voltage generator is fixedly connected to the interior of the placement slot through fixing bolts.

Further, one end of the metal dust collection support is fixedly connected to the top of the base through fixing bolts, the other end of the metal dust collection support is fixedly connected to the bottom of the top cover through fixing bolts, and the metal electrode sheet has a discharge electrode and a dust collecting electrode.

Further, an air blower support is fixedly connected between the top cover and the base, a plurality of fan blade mounting slots are formed in the air blower support, air blowers are fixedly connected to the interiors of the plurality of fan blade mounting slots, and the air blower support is located between the rear grille and the metal dust collection support.

Further, the filtering mechanism further includes a high-voltage tungsten wire assembly fixedly connected to the top cover and the base through fixing bolts, and a high-voltage tungsten wire is fixedly connected to the interior of the high-voltage tungsten wire assembly; a distance between the high-voltage tungsten wire and the metal dust collection support is 25 mm. A charge field generated within the optimal distance provides the optimal air purification effect against PM2.5.

Further, the top cover and the base are respectively fixedly connected to the top and bottom ends of the front grille and the rear grille through fixing bolts, and the side baffles are respectively fixedly connected to the front grille and the rear grille through fixing bolts.

Further, one ends of the low-voltage terminal and the ground terminal are respectively fixedly connected to one of the side baffles through bolts, and the bottom of the base is fixedly connected to a bottom plate.

Compared with the prior art, the present invention has the following beneficial effects.
1. According to the present invention, a dust collection mechanism, in which the metal dust collection support is washable and reusable, is installed, thereby reducing waste and environmental pollution;
2. According to the present invention, a filtering mechanism, in which the distance between the high-voltage tungsten wire and the metal dust collection support is 25 mm, is installed, and the charge field generated within the optimal distance provides the optimal air purification effect against PM2.5. By virtue of the ozone filter, the ozone production of the entire machine is reduced to the greatest extent.

In summary, the electrostatic dust collector-purifier has a novel design and is simple to operate. The electrostatic dust collector-purifier positively charges the dust in the air in accordance with the principle of anode corona discharge and then captures the charged particles on the dust collection device by virtue of the Coulomb force, thereby achieving the purpose of dust removal and air purification and also purifying the generated ozone. In this way, the electrostatic dust collector-purifier can not only quickly capture microparticles in the air, but also perform ozone filtration, thereby effectively improving the effect and efficiency of air purification.

### BRIEF DESCRIPTION OF DRAWINGS

FIG. 1 is a schematic overall cross-sectional diagram of an electrostatic dust collector-purifier according to the present invention, viewed from the front;

FIG. 2 is a schematic overall three-dimensional diagram of internal parts of the electrostatic dust collector-purifier according to the present invention;

FIG. 3 is a schematic three-dimensional diagram of a metal dust collection support of the electrostatic dust collector-purifier according to the present invention, viewed from the top;

FIG. 4 is a schematic three-dimensional diagram of some parts of a filtering mechanism in the electrostatic dust collector-purifier according to the present invention, viewed from the top;

FIG. 5 is a schematic three-dimensional diagram of a high-voltage tungsten wire assembly of the electrostatic dust collector-purifier according to the present invention;

FIG. 6 is a schematic three-dimensional diagram of a front grille of the electrostatic dust collector-purifier according to the present invention, viewed from the top;

FIG. 7 is a partially enlarged schematic three-dimensional diagram of the electrostatic dust collector-purifier according to the present invention shown in FIG. 2; and

FIG. 8 is a schematic three-dimensional diagram of a base and a bottom plate of the electrostatic dust collector-purifier according to the present invention.

In the figures: 1. high-voltage generator; 2. low-voltage terminal; 3. terminal; 4. metal dust collection support; 5. ozone filter; 6. high-voltage tungsten wire assembly; 7. front grille; 8. top cover; 9. base; 10. bottom plate; 11. power cord; 12. side baffle; 13. rear grille; 14. air blower support; 15. filter support; and 16. metal electrode sheet.

### DETAILED DESCRIPTION OF THE INVENTION

The technical solutions in the embodiments of the invention will be described clearly and completely below in connection with the drawings in the embodiments of the invention, and it will be apparent that the embodiments described here are merely illustrative ones, and are not all possible ones of the invention. All other embodiments obtained by a person of ordinary skill in the art based on the embodiments of the invention without creative efforts shall fall within the scope of the invention.

As described herein, it should be understood that the orientations or positional relationships, indicated by the terms “central”, “longitudinal”, “lateral”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, and the like, are based on the orientations or positional relationships shown in the drawings and are only for the purpose of facilitating and simplifying the description of the invention, rather than indicating or implying that the described device or element must have a particular orientation or must be constructed and operated in a particular orientation, and therefore they cannot to be construed as limiting the invention.

Moreover, the terms “first” and “second” are merely used for descriptive purposes and should not be construed as indicating or implying a relative importance or implicitly indicating the number of technical features indicated. Therefore, a feature limited by “first” or “second” may explicitly or implicitly include one or more of the features. As described herein, “a plurality of” means two or more, unless specifically defined otherwise. In addition, the terms “install”, “connect” and “connection” should be understood in a broad sense. For example, the connection may be fixed connection, detachable connection, or integrated connection; may be mechanical connection or electrical connection; may be direct connection, an indirect connection by virtue of an intermediate medium, or internal connection between two elements. For those skilled in the art, the specific meanings of the above terms in the invention could be understood in specific situations. The invention will be further described in detail below with reference to the accompanying drawings.

### Embodiment 1

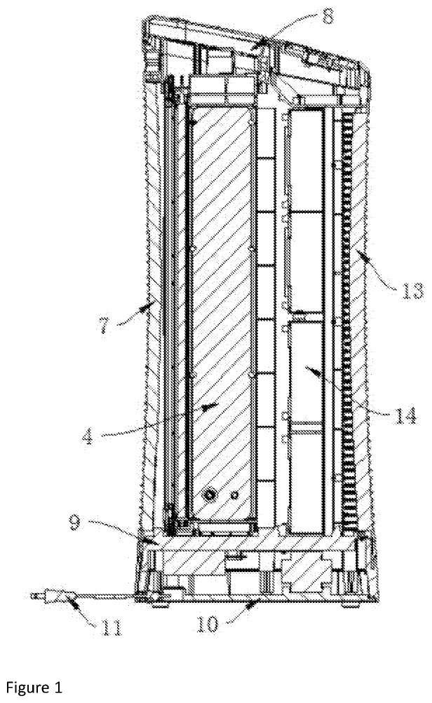

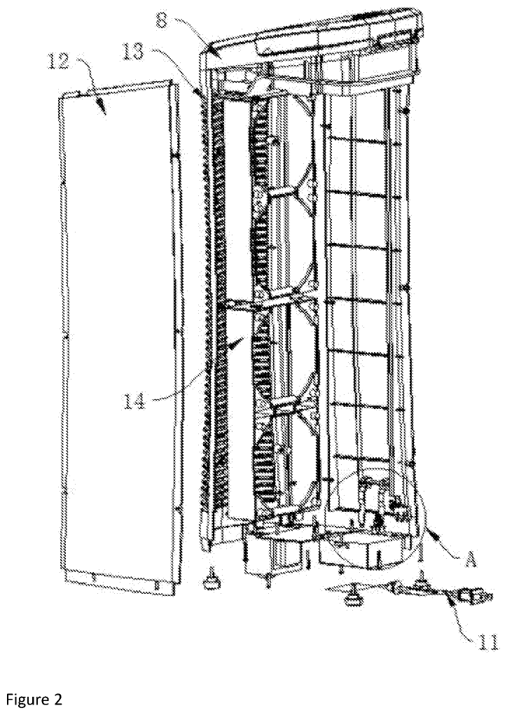

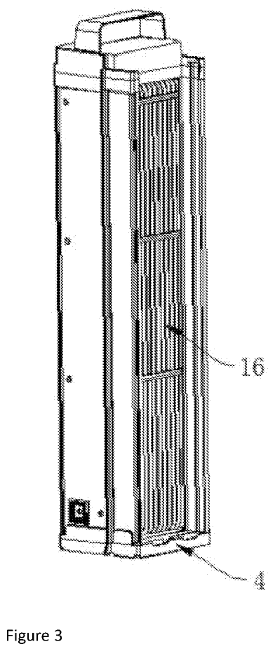

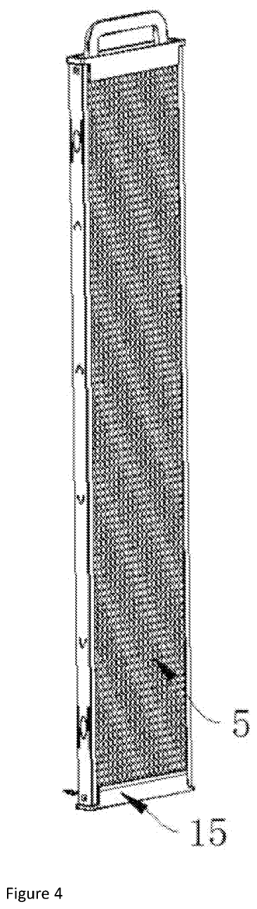

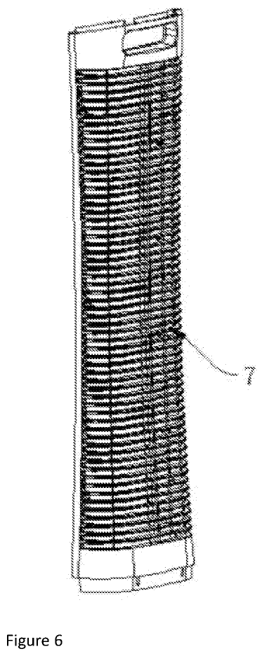

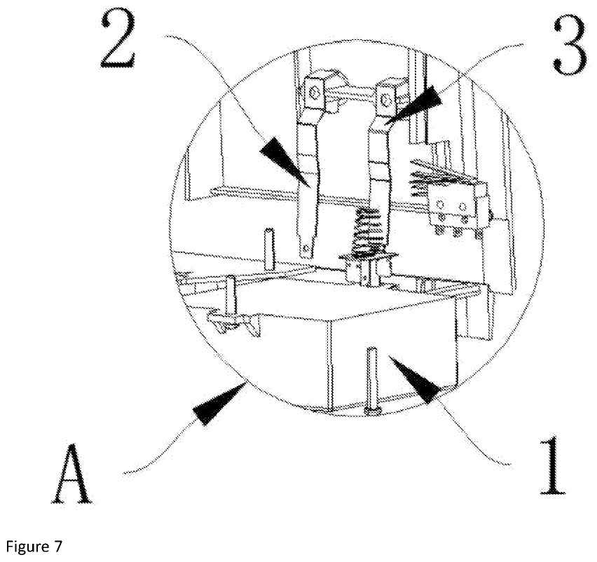

Referring to FIGS. 1-4 and 6-8, an electrostatic dust collector-purifier includes a top cover 8, a base 9, two side baffles 12, a front grille 7, a rear grille 13, a power generation mechanism, the power generation mechanism being located inside the base 9, and including a high-voltage generator 1, a low-voltage terminal 2 fixedly connected to one side of the high-voltage generator 1, and a ground terminal 3 fixedly connected to one side of the high-voltage generator;
a dust collection mechanism, the dust collection mechanism being located between the base 9 and the top cover 8, and including a metal dust collection support 4 and a metal electrode sheet 16 fixedly connected to the interior of the metal dust collection support; and
a filtering mechanism, the filtering mechanism being located between the base 9 and the top cover 8 as well as between the front grille 7 and the metal dust collection support 4, and including a filter support 15 and an ozone filter 5 fixedly connected to the interior of the filter support 15.

In the present invention, the power generation mechanism further includes a power cord 11 fixedly connected to the high-voltage generator 1, one end of the power cord is connected to an input end of the high-voltage generator 1, a placement slot is provided inside the base 9, the high-voltage generator 1 is fixedly connected to the interior of the placement slot through fixing bolts, and anode corona discharge is performed through the high-voltage generator 1.

In the present invention, one end of the metal dust collection support 4 is fixedly connected to the top of the base 9 through fixing bolts, the other end of the metal dust collection support 4 is fixedly connected to the bottom of the top cover 8 through fixing bolts, and the metal electrode sheet 16 has a discharge electrode and a dust collecting electrode. The discharge electrode carries out discharge treatment, and in the meanwhile the dust collecting electrode acts to capture particles in the air.

In the present invention, an air blower support 14 is fixedly connected between the top cover 8 and the base 9, a plurality of fan blade mounting slots are formed in the air blower support 14, air blowers are fixedly connected to the interiors of the plurality of fan blade mounting slots, the air blower support 14 is located between the rear grille 13 and the metal dust collection support 4. The air is transported and treated through the air blowers, which effectively improves the efficiency of air purification.

### Embodiment 2

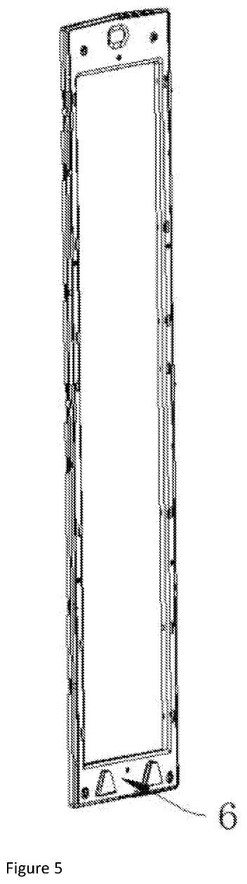

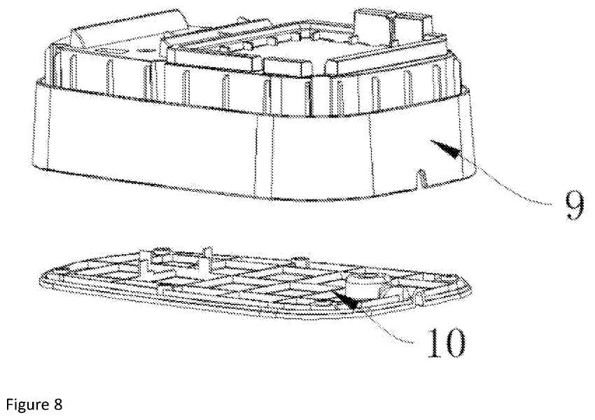

Referring to FIGS. 5 and 8, this embodiment provides, on the basis of Embodiment 1, a technical solution: the filtering mechanism further includes a high-voltage tungsten wire assembly 6 fixedly connected to the top cover 8 and the base 9 through fixing bolts, and a high-voltage tungsten wire is fixedly connected to the interior of the high-voltage tungsten wire assembly 6; a distance between the high-voltage tungsten wire and the metal dust collection support 4 is 25 mm. A charge field generated within the optimal distance provides the optimal air purification effect against PM2.5.

In the present invention, the top cover 8 and the base 9 are respectively fixedly connected to the top and bottom ends of the front grille 7 and the rear grille 13 through fixing bolts, and the side baffles 12 are respectively fixedly connected to the front grille 7 and the rear grille 13 through fixing bolts.

In the present invention, one ends of the low-voltage terminal 2 and the ground terminal 3 are respectively fixedly connected to one of the side baffles 12 through bolts, and the bottom of the base 9 is fixedly connected to a bottom plate 10.

The above are only preferred embodiments of the invention, but the scope of the invention is not limited to thereto. Those familiar with the technical field shall make equivalent substitutions or changes on the basis of the technical solutions and inventive concepts of the invention within the technical scope disclosed in the invention, and they shall be included within the scope of the invention.

1. An electrostatic dust collector-purifier, comprising a top cover (8), a base (9), two side baffles (12), a front grille (7), and a rear grille (13), further comprising
a power generation mechanism, the power generation mechanism being located inside the base (9) and comprising a high-voltage generator (1), a low-voltage terminal (2) fixedly connected to one side of the high-voltage generator (1), and a ground terminal (3) fixedly connected to one side of the high-voltage generator (1);
a dust collection mechanism, the dust collection mechanism being located between the base (9) and the top cover (8), and comprising a metal dust collection support (4) and a metal electrode sheet (16) fixedly connected to the interior of the metal dust collection support (4); and
a filtering mechanism, the filtering mechanism being located between the base (9) and the top cover (8) as well as between the front grille (7) and the metal dust collection support (4), and comprising a filter support (15) and an ozone filter (5) fixedly connected to interior of the filter support (15).

2. The electrostatic dust collector-purifier according to claim 1, wherein the power generation mechanism further comprises a power cord (11) fixedly connected to the high-voltage generator (1), one end of the power cord (11) is connected to an input end of the high-voltage generator (1), a placement slot is provided inside the base (9), and the high-voltage generator (1) is fixedly connected to the interior of the placement slot through fixing bolts.

3. The electrostatic dust collector-purifier according to claim 1, wherein one end of the metal dust collection support (4) is fixedly connected to the top of the base (9) through fixing bolts, the other end of the metal dust collection support (4) is fixedly connected to the bottom of the top cover (8) through fixing bolts, and the metal electrode sheet (16) has a discharge electrode and a dust collecting electrode.

4. The electrostatic dust collector-purifier according to claim 1, wherein an air blower support (14) is fixedly connected between the top cover (8) and the base (9), a plurality of fan blade mounting slots are formed in the air blower support (14), air blowers are fixedly connected to interiors of the plurality of fan blade mounting slots, and the air blower support (14) is located between the rear grille (13) and the metal dust collection support (4).

5. The electrostatic dust collector-purifier according to claim 1, wherein the filtering mechanism further comprises a high-voltage tungsten wire assembly (6) fixedly connected to the top cover (8) and the base (9) through fixing bolts, and a high-voltage tungsten wire is fixedly connected to the interior of the high-voltage tungsten wire assembly (6); a distance between the high-voltage tungsten wire and the metal dust collection support (4) is 25 mm.

6. The electrostatic dust collector-purifier according to claim 1, wherein the top cover (8) and the base (9) are respectively fixedly connected to the top and bottom ends of the front grille (7) and the rear grille (13) through fixing bolts, and the side baffles 12 are respectively fixedly connected to the front grille (7) and the rear grille (13) through fixing bolts.

7. The electrostatic dust collector-purifier according to claim 1, wherein one ends of the low-voltage terminal (2) and the ground terminal (3) are respectively fixedly connected to one of the side baffles (12) through bolts, and the bottom of the base (9) is fixedly connected to a bottom plate (10).
